(19) United States
(12) Patent Application Publication
(10) Pub. No.: US 2018/0056953 A1
(43) Pub. Date: Mar. 1, 2018

(54) BRAKE CONTROL DEVICE

(71) Applicant: TOYOTA JIDOSHA KABUSHIKI KAISHA, Toyota-shi (JP)

(72) Inventor: Hidehisa KATO, Shizuoka-ken (JP)

(73) Assignee: TOYOTA JIDOSHA KABUSHIKI KAISHA, Toyota-shi (JP)

(21) Appl. No.: 15/602,849

(22) Filed: May 23, 2017

(30) Foreign Application Priority Data
Aug. 29, 2016 (JP) 2016-167002

(51) Int. Cl. B60T 8/1761; B60T 8/1755; B60T 13/14; B60T 13/68; B60T 7/12

(52) U.S. Cl. CPC B60T 8/1761; B60T 8/1755; B60T 2201/04; B60T 13/686; B60T 7/12; B60T 13/142

(57) ABSTRACT

A brake control device for a vehicle, includes: a master cylinder outputting a brake fluid of a master pressure; a master pressure changing device for changing the master pressure; a brake actuator for controlling a brake pressure of the brake fluid supplied from the master cylinder to a wheel cylinder; and a control device performing an automatic brake control including first and second modes. In the first mode, the control device operates the brake actuator to make a target value of the brake pressure. In the second mode, the control device operates the master pressure changing device such that the master pressure becomes the target value of the brake pressure to change the brake pressure of the target wheel in conjunction with the master pressure. The control device selects one of the first and second modes depending on a type of the automatic brake control.

### TECHNICAL FIELD

The present invention relates to a brake control device for a vehicle. In particular, the present invention relates to a brake control device that performs an automatic brake control.

### BACKGROUND ART

Patent Literature 1 discloses a vehicle control device. The vehicle control device is provided with a master cylinder, a servo pressure generation device, and a brake actuator. The servo pressure generation device generates a servo pressure independently of a driver's operation of a brake pedal. The master cylinder operates based on the servo pressure and outputs, to the brake actuator, a brake fluid of a master pressure according to the servo pressure. The brake actuator distributes the brake fluid output from the master cylinder to respective wheel cylinders of wheels. Moreover, the brake actuator is able to individually control pressures of the brake fluid supplied to the respective wheel cylinders of the wheels.

A vehicle stability control (VSC) and a traction control are known as examples of an automatic brake control that automatically changes a brake pressure of a wheel cylinder independently of an operation of the brake pedal. When performing such the automatic brake control, the vehicle control device sets the servo pressure and the master pressure higher than a target value of the brake pressure of the wheel cylinder and uses the brake actuator to control the brake pressure. More specifically, the vehicle control device controls opening/closing of a pressure increase valve and a pressure reduction valve included in the brake actuator such that the target value of the brake pressure is achieved. During such the valve open-close control, a difference between the master pressure and the brake pressure causes a large variation in a hydraulic pressure, which consequently causes vibrations and hydraulic hammer sounds.

According to the technique disclosed in Patent Literature 1, the vehicle control device sets initial values of the servo pressure and the master pressure relatively low in order to suppress the hydraulic pressure variation during the automatic brake control. After that, the vehicle control device increases levels of the servo pressure and the master pressure in a step-by-step manner as needed.

### LIST OF RELATED ART

Patent Literature 1: JP-2015-143058

### SUMMARY

As described above, when the automatic brake control is performed, noises and vibrations (NV) are caused due to an operation of the brake actuator. Even in the case of the technique disclosed in Patent Literature 1, the noises and vibrations are caused to some extent.

An object of the present invention is to provide a technique that can suppress the noises and vibrations caused when the automatic brake control is performed.

A first invention provides a brake control device for a vehicle.

The brake control device includes:

a master cylinder configured to output a brake fluid of a master pressure;

a master pressure changing device configured to change the master pressure independently of an operation of a brake pedal;

a brake actuator configured to supply the brake fluid output from the master cylinder to a wheel cylinder of each wheel, and to control a brake pressure of the brake fluid supplied to the wheel cylinder; and

a control device configured to perform an automatic brake control that changes the brake pressure of a target wheel independently of an operation of the brake pedal.

Modes of the automatic brake control include a first mode and a second mode.

In the first mode, the control device operates the brake actuator to make a target value of the brake pressure of the target wheel.

In the second mode, the control device operates the master pressure changing device such that the master pressure becomes the target value of the brake pressure to change the brake pressure of the target wheel in conjunction with the master pressure.

The control device selects one of the first mode and the second mode depending on a type of the automatic brake control.

A second invention further has the following features in addition to the first invention.

The control device retains mode specifying information that indicates whether to use the first mode or the second mode with respect to each type of the automatic brake control.

When performing the automatic brake control, the control device refers to the mode specifying information to select one mode specified with respect to the type of the automatic brake control.

A third invention further has the following features in addition to the first or second invention.

When the automatic brake control is a vehicle stability control for stabilizing a behavior of the vehicle during cornering, the control device selects the first mode.

A fourth invention further has the following features in addition to any one of the first to third inventions.

When the automatic brake control is an anti-lock brake control for preventing a wheel from locking up during braking, the control device selects the first mode.

A fifth invention further has the following features in addition to any one of the first to fourth inventions.

When the automatic brake control is a traction control for suppressing wheel spin when starting or accelerating, the control device selects the second mode.

A sixth invention has the following features in addition to any one of the first to fifth inventions.

When the automatic brake control is a downhill assist control for assisting driving of the vehicle on a downhill, the control device selects the second mode.

A seventh invention has the following features in addition to any one of the first to sixth inventions.

When the automatic brake control is a crawl control for assisting crawl running of the vehicle, the control device selects the second mode.

An eighth invention has the following features in addition to any one of the first to seventh inventions.

The brake actuator includes:

an input node to which the brake fluid output from the master cylinder is input;

a pressure increase valve provided between the input node and the wheel cylinder with respect to each wheel;

a pressure reduction valve provided between the wheel cylinder and a reservoir with respect to each wheel; and

a pump configured to return the brake fluid from the reservoir to the input node.

When increasing the brake pressure of the target wheel in the first mode, the control device opens the pressure increase valve for the target wheel and closes the pressure reduction valve for the target wheel.

When decreasing the brake pressure of the target wheel in the first mode, the control device closes the pressure increase valve for the target wheel and opens the pressure reduction valve for the target wheel.

When changing the brake pressure of the target wheel in the second mode, the control device opens the pressure increase valve for the target wheel, closes the pressure reduction valve for the target wheel, and uses the master pressure changing device to change the master pressure.

According to the first invention, the automatic brake control in the second mode is available in addition to the conventional first mode. In the second mode, the brake pressure of the target wheel varies in conjunction with the master pressure, and thus the noises and vibrations are dramatically reduced as compared with the first mode. Therefore, by using the second mode as needed, it is possible to suppress the noises and vibrations during the automatic brake control as compared with a conventional technique where only the first mode is used. In addition to that, the first mode may be used in a case of the automatic brake control that gives priority to response ability. By appropriately selecting an usage mode depending on the type of the automatic brake control, it is possible to balance between the NV characteristics and the response ability.

According to the second invention, the mode specifying information is prepared beforehand, and the mode specifying information is referred to when the usage mode is selected. As a result, it is possible to easily and quickly select the usage mode.

According to the third invention, it is possible to effectively perform the vehicle stability control by using the first mode with excellent response ability.

According to the fourth invention, it is possible to effectively perform the anti-lock brake control by using the first mode with excellent response ability.

According to the fifth invention, it is possible to reduce the noises and vibrations when the traction control is performed, by using the second mode with excellent NV characteristics.

According to the sixth invention, it is possible to reduce the noises and vibrations when the downhill assist control is performed, by using the second mode with excellent NV characteristics.

According to the seventh invention, it is possible to reduce the noises and vibrations when the crawl control is performed, by using the second mode with excellent NV characteristics.

According to the eighth invention, it is possible, in the first mode, to control the brake pressure of the target wheel by operating the brake actuator. Moreover, in the second mode, it is possible to change the brake pressure of the target wheel in conjunction with the master pressure by operating the master pressure changing device.

### BRIEF DESCRIPTION OF DRAWINGS

FIG. 1 is a schematic diagram showing a configuration example of a vehicle according to an embodiment of the present invention;

FIG. 2 is a diagram showing a configuration example of a brake control device according to the embodiment of the present invention;

FIG. 3 is a diagram showing a configuration example of a brake actuator according to the embodiment of the present invention;

FIG. 4 is a timing chart for explaining a first mode of an automatic brake control according to the embodiment of the present invention;

FIG. 5 is a timing chart for explaining a second mode of the automatic brake control according to the embodiment of the present invention;

FIG. 6 is a conceptual diagram for explaining the second mode of the automatic brake control according to the embodiment of the present invention;

FIG. 7 is a diagram for explaining NV characteristics of the first mode and the second mode in the embodiment of the present invention;

FIG. 8 is a diagram for explaining NV characteristics of the first mode and the second mode in the embodiment of the present invention;

FIG. 9 is a conceptual diagram showing types of the automatic brake control to which the first mode is applied and types of the automatic brake control to which the second mode is applied according to the embodiment of the present invention;

FIG. 10 is a block diagram showing functions of a brake ECU according to the embodiment of the present invention; and

FIG. 11 is a flow chart showing the automatic brake control according to the embodiment of the present invention.

### EMBODIMENTS

Embodiments of the present invention will be described below with reference to the attached drawings.
1. Schematic Configuration of Vehicle

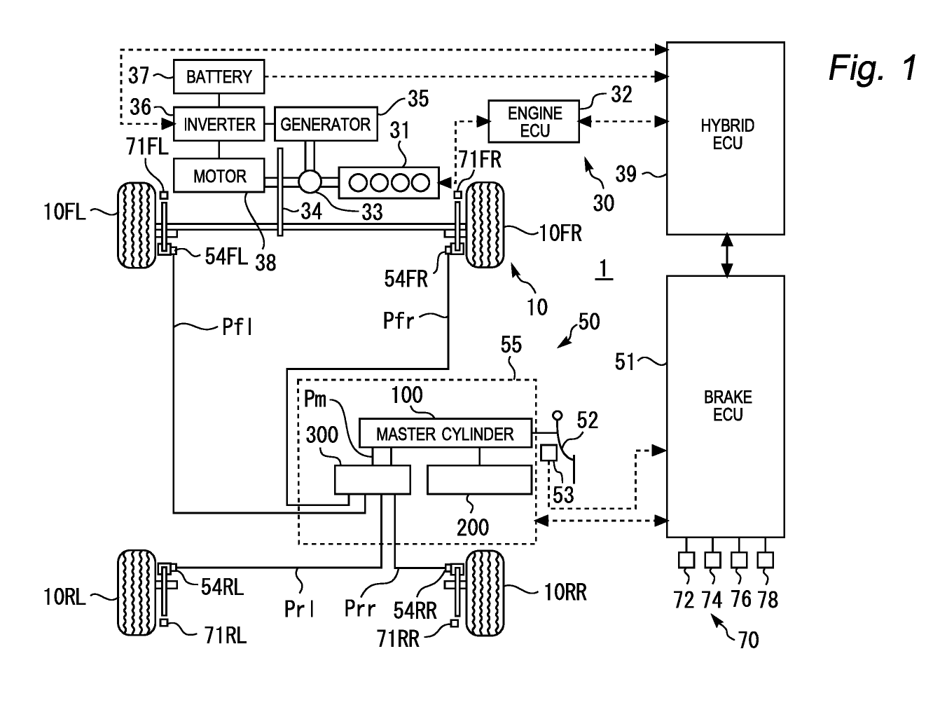

FIG. 1 is a schematic diagram showing a configuration example of a vehicle 1 according to an embodiment of the present invention. The vehicle 1 is provided with wheels 10, a driving control device 30, a brake control device 50, and a sensor group 70.
1-1. Wheels 10

The wheels 10 include a left front wheel 10FL, a right front wheel 10FR, a left rear wheel 10RL, and a right rear wheel 10RR.
1-2. Driving control device 30

The driving control device 30 includes an engine 31, an engine ECU (Electronic Control Unit) 32, a power division mechanism 33, a power transmission mechanism 34, a generator 35, an inverter 36, a battery 37, a motor 38, and a hybrid ECU 39.

The engine 31 is a power source. The engine ECU 32 controls an operation of the engine 31. The power division mechanism 33 distributes a driving force generated by the engine 31 to the power transmission mechanism 34 and the generator 35. The power transmission mechanism 34 transmits the driving force to driving wheels (i.e. the left front wheel 10FL and the right front wheel 10FR in the present example). The generator 35 generates AC power by the received driving force. The inverter 36 converts the AC power generated by the generator 35 into DC power and supplies the DC power to the battery 37 to charge the battery 37.

The motor 38 is another power source. The inverter 36 converts DC power output from the battery 37 into AC power and supplies the AC power to the motor 38 to perform a driving control of the motor 38. A driving force generated by the motor 38 is transmitted to the driving wheels through the power transmission mechanism 34.

The motor 38 functions also as a means for generating a regenerative braking force. More specifically, when the vehicle 1 is moving and neither the engine 31 nor the motor 38 generates the driving force, a rotational force of the driving wheels is transmitted to the motor 38 through the power transmission mechanism 34. In this case, the motor 38 serves as a power generator, and a rotational resistance during the power generation serves as a braking force for the driving wheels. The inverter 36 converts AC power generated by the regenerative power generation by the motor 38 into DC power and supplies the DC power to the battery 37 to charge the battery 37.

The hybrid ECU 39 performs a hybrid operation control with the use of the two power sources, the engine 31 and the motor 38. More specifically, the hybrid ECU 39 issues an instruction to the engine ECU 32 to control the driving force generation by the engine 31. Moreover, the hybrid ECU 39 controls the inverter 36 to control the driving force generation by the motor 38. Additionally, the hybrid ECU 39 controls the inverter 36 to perform a control (regeneration control) of the regenerative braking force. Furthermore, the hybrid ECU 39 monitors a state of charge of the battery 37 and controls the inverter 36 to control charging and discharging of the battery 37.
1-3. Brake control device 50

The brake control device 50 includes a brake ECU 51, a brake pedal 52, a stroke sensor 53, wheel cylinders 54FL, 54FR, 54RL, and 54RR, and a brake pressure generation device 55.

The brake ECU 51 is a control device for controlling an operation of the brake control device 50. The brake pedal 52 is an operating member used by a driver for performing a braking operation. The stroke sensor 53 detects a stroke amount (operation amount) of the brake pedal 52. The stroke sensor 53 sends information on the detected stroke amount to the brake ECU 51.

The wheel cylinders 54FL, 54FR, 54RL, and 54RR are provided for the left front wheel 10FL, the right front wheel 10FR, the left rear wheel 10RL, and the right rear wheel 10RR, respectively. Braking forces at the left front wheel 10FL, the right front wheel 10FR, the left rear wheel 10RL, and the right rear wheel 10RR are respectively determined depending on pressures of brake fluids supplied to the wheel cylinders 54FL, 54FR, 54RL, and 54RR. The pressures of the brake fluids supplied to the wheel cylinders 54FL, 54FR, 54RL, and 54RR are hereinafter referred to as brake pressures Pfl, Pfr, Prl, and Prr, respectively.

The brake pressure generation device 55 supplies the brake fluids to the wheel cylinders 54FL, 54FR, 54RL, and 54RR to generate the brake pressures Pfl, Pfr, Prl, and Prr. Moreover, the brake pressure generation device 55 has a function of variably controlling each of the brake pressures Pfl, Pfr, Prl, and Prr.

Here, although the brake pedal 52 is connected to the brake pressure generation device 55, an operation of the brake pressure generation device 55 is not necessarily directly connected to an operation of the brake pedal 52. As an example, let us consider a case where the regenerative braking force mentioned above is used. When a driver steps on the brake pedal 52, the stroke sensor 53 sends information on a stroke amount of the brake pedal 52 to the brake ECU 51. The brake ECU 51 calculates, based on the stroke amount, a requested braking force requested by the driver. Then, the brake ECU 51 sends information on the requested braking force to the hybrid ECU 39. The hybrid ECU 39 performs the regeneration control based on the requested braking force to generate the regenerative braking force. The hybrid ECU 39 sends information on the generated regenerative braking force to the brake ECU 51. The brake ECU 51 subtracts the regenerative braking force from the requested braking force to calculate a target friction braking force. The target friction braking force is a braking force that the brake control device 50 (i.e. the brake pressure generation device 55) should bear. The brake ECU 51 controls an operation of the brake pressure generation device 55 such that the brake pressures Pfl, Pfr, Prl, and Prr corresponding to the target friction braking force are generated.

As seen from the above, the brake pressure generation device 55 according to the present embodiment is configured to control the brake pressures Pfl, Pfr, Prl, and Prr at least in accordance with an instruction from the brake ECU 51. In other words, the brake pressure generation device 55 is able to control the brake pressures Pfl, Pfr, Prl, and Prr independently of an operation of the brake pedal 52. The brake ECU 51 can control the operation of the brake pressure generation device 55 not only for the above-described regenerative braking force but also for a variety of purposes.

It should be noted that the brake ECU 51 is a microcomputer provided with a processor, a memory, and an input/output interface. The brake ECU 51 receives detected information from a variety of sensors and sends an instruction to the brake pressure generation device 55 through the input/output interface. A control program is stored in the memory, and the processor executes the control program to achieve functions of the brake ECU 51.

1-4. Sensor group 70

The sensor group 70 includes wheel speed sensors 71FL, 71FR, 71RL, and 71RR, a steering angle sensor 72, a vehicle speed sensor 74, a lateral acceleration sensor 76, a yaw rate sensor 78, and so forth. The wheel speed sensors 71FL, 71FR, 71RL, and 71RR detect rotational speeds of the left front wheel 10FL, the right front wheel 10FR, the left rear wheel 10RL, and the right rear wheel 10RR, respectively. The steering angle sensor 72 detects a steering angle. The vehicle speed sensor 74 detects a speed of the vehicle 1. The lateral acceleration sensor 76 detects a lateral acceleration (lateral G) acting on the vehicle 1. The yaw rate sensor 78 detects an actual yaw rate of the vehicle 1.
2. Configuration Example of Brake Control Device

A configuration of the brake control device 50, especially that of the brake pressure generation device 55 will be described below in more detail. As shown in FIG. 1, the brake pressure generation device 55 includes a master cylinder 100, a master pressure changing device 200, and a brake actuator 300.

The master cylinder 100 is a supply source of the brake fluid. The master cylinder 100 pushes out or pulls in the brake fluid in response to an external force. A pressure of the brake fluid output from the master cylinder 100 is hereinafter referred to as a “master pressure Pm”.

The master pressure changing device 200 applies the external force to the master cylinder 100 independently of an operation of the brake pedal 52. When the master pressure changing device 200 increases the external force, the brake fluid is pushed out from the master cylinder 100, and thereby the master pressure Pm is increased. On the other hand, when the master pressure changing device 200 decreases the external force, the brake fluid is pulled into the master cylinder 100, and thereby the master pressure Pm is decreased. That is, the master pressure changing device 200 is able to change the master pressure Pm independently of an operation of the brake pedal 52. The operation of the master pressure changing device 200 is controlled by the brake ECU 51.

The brake actuator 300 is provided between the master cylinder 100 and the wheel cylinders 54FL, 54FR, 54RL, and 54RR. The brake actuator 300 distributes the brake fluid output from the master cylinder 100 to the wheel cylinders 54FL, 54FR, 54RL, and 54RR to generate the brake pressures Pfl, Pfr, Prl, and Prr. Basically, the brake pressures Pfl, Pfr, Prl, and Prr vary depending on the master pressure Pm. Moreover, the brake actuator 300 is able to control the brake pressures Pfl, Pfr, Prl, and Prr individually. The operation of the brake actuator 300 also is controlled by the brake ECU 51.

A concrete configuration example of the master cylinder 100, the master pressure changing device 200, and the brake actuator 300 will be described hereinafter.
2-1. Master cylinder 100

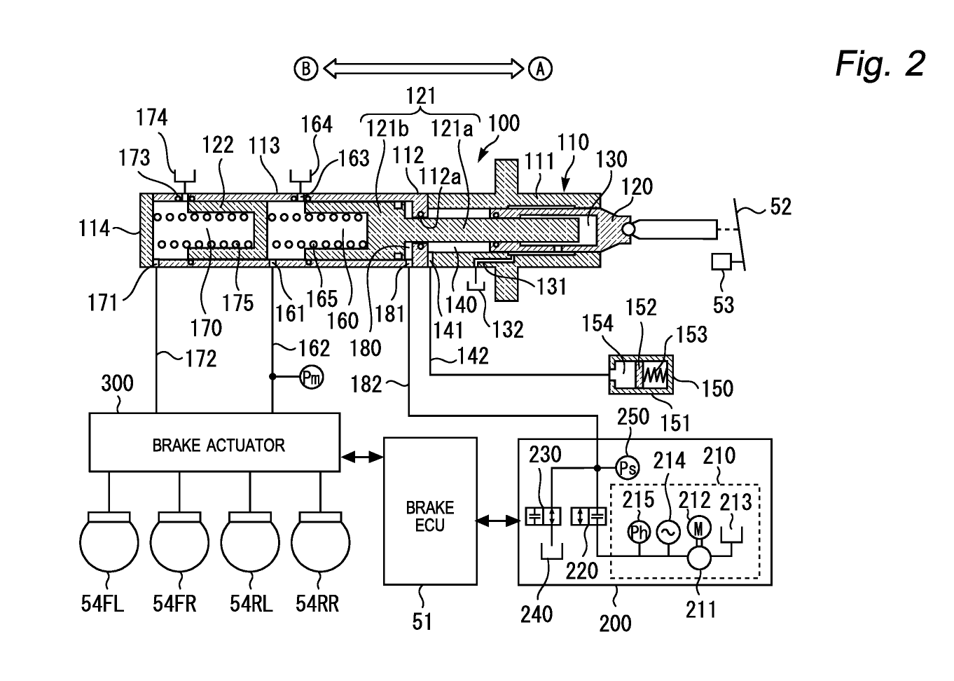

A configuration example of the master cylinder 100 is shown in FIG. 2. The master cylinder 100 has a cylinder 110 whose one end is open and whose other end is closed. In the description below, the open side of the cylinder 110 is referred to as a “A-side” and the closed side thereof is referred to as a “B-side”.

The cylinder 110 consists of an input cylinder 111, a partition 112, an output cylinder 113, and a bottom portion 114, and these are arranged in this order from the A-side to the B-side. One end of the input cylinder 111 is equivalent to the opening end of the cylinder 110, and the bottom portion 114 is equivalent to the closed end of the cylinder 110. The partition 112 is arranged between the input cylinder 111 and the output cylinder 113. The partition 112 has a through-hole 112a. An inside diameter of the through-hole 112a is smaller than an inside diameter of the input cylinder 111 and an inside diameter of the output cylinder 113.

An input piston 120, a first output piston 121, and a second output piston 122 are arranged within the cylinder 110. The input piston 120, the first output piston 121, and the second output piston 122 are arranged in this order from the A-side to the B-side along an axial direction of the cylinder 110.

More specifically, the input piston 120 is arranged so as to be slidable along an inner wall of the input cylinder 111. The input piston 120 is coupled to the brake pedal 52 through an operating rod. The input piston 120 moves back and forth in conjunction with a driver's operation of the brake pedal 52.

The first output piston 121 has a projecting portion 121a on the A-side and a piston section 121b on the B-side. The projecting portion 121a extends from the output cylinder 113 into the input cylinder 111 through the through-hole 112a of the partition 112. However, the projecting portion 121a is not coupled to the input piston 120 and is unaffected by the movement of the input piston 120. As shown in FIG. 2, a separation space 130 is formed between the input piston 120 and the projecting portion 121a. The separation space 130 is connected to a reservoir 132 through a passage 131.

A space surrounded by the input cylinder 111, the partition 112, a front edge of the input piston 120, and the projecting portion 121a is a reaction force chamber 140. The reaction force chamber 140 is filled with a brake fluid. The reaction force chamber 140 is connected to a stroke simulator 150 through a port 141 and a pipe 142.

The stroke simulator 150 has a cylinder 151, a piston 152, a spring 153, and a fluid chamber 154. One end of the cylinder 151 is open, and the other end thereof is closed. The piston 152 is arranged so as to be slidable along an inner wall of the cylinder 151. The piston 152 is connected to the closed end of the cylinder 151 through a spring 153. The fluid chamber 154 is formed between the opening end of the cylinder 151 and the piston 152, and is filled with a brake fluid. The fluid chamber 154 is connected to the reaction force chamber 140 through the pipe 142 and the port 141.

When the driver steps on the brake pedal 52, the input piston 120 moves in the B-direction. As a result, the brake fluid flows from the reaction force chamber 140 into the fluid chamber 154 of the stroke simulator 150, and thus the piston 152 is pushed toward the closed end of the cylinder 151. An elastic force of the spring 153 thus generated causes increase in the fluid pressure in the reaction force chamber 140, and the driver feels it as a reaction force. The elastic force of the spring 153, namely the reaction force is proportional to the amount of movement of the input piston 120. It can be said that the stroke simulator 150 creates a pseudo operation feeling when the driver steps on the brake pedal 52.

The piston section 121b of the first output piston 121 is arranged so as to be slidable along an inner wall of the output cylinder 113. A space surrounded by the output cylinder 113, the piston section 121b, and the second output piston 122 is a first master chamber 160. The first master chamber 160 is filled with a brake fluid. The first master chamber 160 is connected to the brake actuator 300 through a port 161 and a pipe 162. The first master chamber 160 is connected to a reservoir 164 through a port 163. In the first master chamber 160, a spring 165 is arranged so as to connect between the piston section 121b and the second output piston 122.

The second output piston 122 is arranged so as to be slidable along the inner wall of the output cylinder 113. A space surrounded by the output cylinder 113, the second output piston 122, and the bottom portion 114 of the cylinder 110 is a second master chamber 170. The second master chamber 170 is filled with a brake fluid. The second master chamber 170 is connected to the brake actuator 300 through a port 171 and a pipe 172. The second master chamber 170 is connected to a reservoir 174 through a port 173. In the second master chamber 170, a spring 175 is arranged so as to connect between the second output piston 122 and the bottom portion 114.

A state where the spring 165 and the spring 175 each has no elastic force is an initial state. The initial state is shown in FIG. 2. A pressure of the brake fluid in the initial state is a reservoir pressure.

As shown in FIG. 2, the piston section 121b of the first output piston 121 and the partition 112 are separated from each other, and thus a servo chamber 180 is formed therebetween. The servo chamber 180 is filled with a brake fluid. A pressure of the brake fluid in the servo chamber 180 is hereinafter referred to as a “servo pressure Ps”. The servo chamber 180 is connected to the master pressure changing device 200 through a port 181 and a pipe 182. The master pressure changing device 200 sends the brake fluid into the servo chamber 180 or draws the brake fluid out of the servo chamber 180.

When the master pressure changing device 200 sends the brake fluid into the servo chamber 180, the servo pressure Ps is increased and thus the first output piston 121 moves in the B-direction. When the first output piston 121 moves in the B-direction, communication between the first master chamber 160 and the reservoir 164 is interrupted, and thus the brake fluid pressure in the first master chamber 160 is increased. As a result, the brake fluid is output from the first master chamber 160 to the pipe 162.

At the same time, the increase in the fluid pressure in the first master chamber 160 causes the second output piston 122 to move in the B-direction in conjunction with the first output piston 121. When the second output piston 122 moves in the B-direction, communication between the second master chamber 170 and the reservoir 174 is interrupted, and thus the brake fluid pressure in the second master chamber 170 is increased. As a result, the brake fluid is output from the second master chamber 170 to the pipe 172.

On the other hand, when the master pressure changing device 200 draws the brake fluid out of the servo chamber 180, the servo pressure Ps is decreased. As a result, the first output piston 121 and the second output piston 122 move in the A-direction, and thus the brake fluid pressures in the first master chamber 160 and the second master chamber 170 are decreased. The brake fluid is pulled into the first master chamber 160 from the pipe 162, and the brake fluid is pulled into the second master chamber 170 from the pipe 172. When the first output piston 121 and the second output piston 122 return to the initial positions in the initial state, the first master chamber 160 is communicated with the reservoir 164 again, and the second master chamber 170 is communicated with the reservoir 174 again.

The pressure of the brake fluid in each of the first master chamber 160 and the second master chamber 170 is the master pressure Pm described above. The master pressure Pm is almost equal to the servo pressure Ps in the servo chamber 180. The servo pressure Ps increases or decreases depending on the state of supply of the brake fluid from the master pressure changing device 200. That is to say, the master pressure Pm can be changed by the master pressure changing device 200.

It should be noted that the configuration of the master cylinder 100 is not limited to that shown in FIG. 2. For example, a master cylinder as disclosed in Patent Literature 1 (JP-2015-143058) may be used. Moreover, a mode where the operation of the brake pedal 52 directly causes change in the master pressure Pm may be used as needed.
2-2. Master pressure changing device 200

A configuration example of the master pressure changing device 200 is shown in FIG. 2. The master pressure changing device 200 has a high-pressure fluid source 210, a pressure increase valve 220, a pressure reduction valve 230, a reservoir 240, and a pressure sensor 250.

The high-pressure fluid source 210 includes a hydraulic pump 211, a motor 212, a reservoir 213, an accumulator 214, and a pressure sensor 215. The hydraulic pump 211 is driven by the motor 212 to draw a brake fluid out of the reservoir 213 and boost a pressure of the brake fluid. The accumulator 214 accumulates the brake fluid whose pressure is boosted. The pressure sensor 215 detects a pressure Ph of the brake fluid accumulated in the accumulator 214. The brake ECU 51 monitors the pressure Ph detected by the pressure sensor 215 and controls the motor 212 such that the pressure Ph is maintained above a certain level.

The pressure increase valve 220 is provided between the high-pressure fluid source 210 and the pipe 182 connected to the servo chamber 180. On the other hand, the pressure reduction valve 230 is provided between the pipe 182 and the reservoir 240. The pressure increase valve 220 is of a normally closed (NC: Normally Closed) type, and the pressure reduction valve 230 is of a normally open (NO: Normally Open) type. By opening the pressure increase valve 220 and closing the pressure reduction valve 230, it is possible to send the high-pressure brake fluid into the servo chamber 180 to increase the servo pressure Ps and thus the master pressure Pm. On the other hand, by closing the pressure increase valve 220 and opening the pressure reduction valve 230, it is possible to draw the brake fluid out of the servo chamber 180 to decrease the servo pressure Ps and thus the master pressure Pm.

The pressure sensor 250 detects a pressure of the brake fluid in the pipe 182, namely the servo pressure Ps. Information on the servo pressure Ps detected by the pressure sensor 250 is sent to the brake ECU 51. The brake ECU 51 controls opening/closing of the pressure increase valve 220 and the pressure reduction valve 230 such that the servo pressure Ps becomes a target value.

It should be noted that the configuration of the master pressure changing device 200 is not limited to that shown in FIG. 2. Any configuration will do as long as it can change the master pressure Pm in accordance with an instruction from the brake ECU 51. For example, a servo pressure generation device disclosed in Patent Literature 1 (JP-2015-143058) may be used as the master pressure changing device 200. Besides, a vacuum servo device or a booster device using a negative pressure in an engine intake system or a vacuum pump may be used for changing the master pressure Pm. In this case, the vacuum servo device or the booster device serves as the master pressure changing device 200.
2-3. Brake Actuator 300

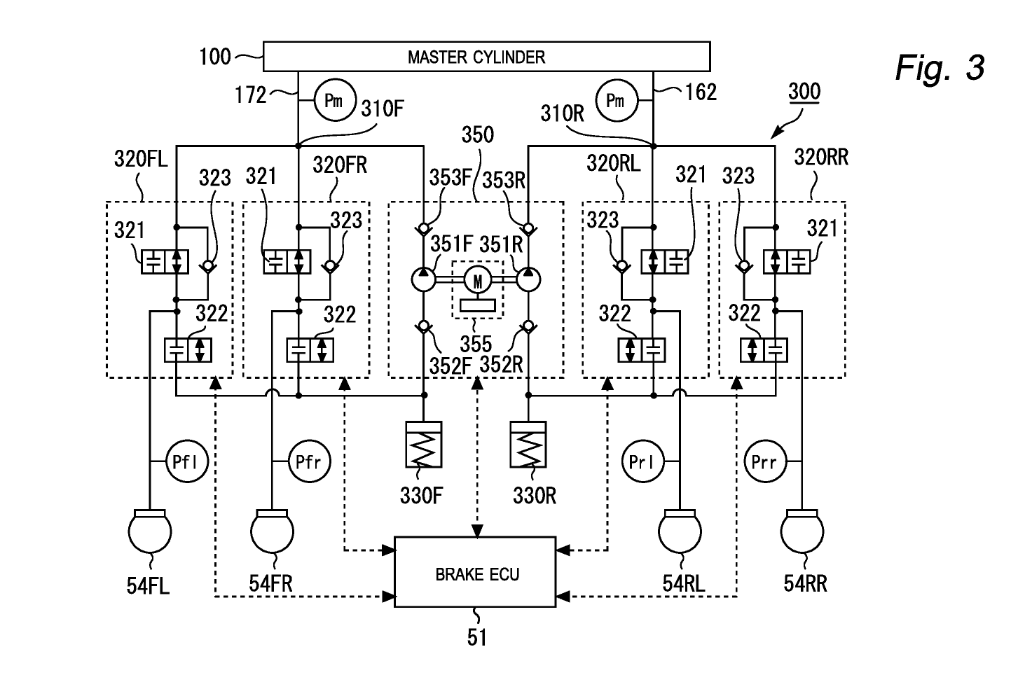

FIG. 3 shows a configuration example of the brake actuator 300. The brake actuator 300 has input nodes 310F and 310R, valve units 320FL, 320FR, 320RL, and 320RR, reservoirs 330F and 330R, and a pump unit 350.

The input node 310F is connected to the second master chamber 170 of the master cylinder 100 through the pipe 172. The brake fluid output from the second master chamber 170 is input to the input node 310F. The input node 310R is connected to the first master chamber 160 of the master cylinder 100 through the pipe 162. The brake fluid output from the first master chamber 160 is input to the input node 310R.

The valve units 320FL, 320FR, 320RL, and 320RR are provided for the wheel cylinders 54FL, 54FR, 54RL, and 54RR, respectively. More specifically, the valve unit 320FL is provided between the input node 310F and the wheel cylinder 54FL. The valve unit 320FR is provided between the input node 310F and the wheel cylinder 54FR. The valve unit 320RL is provided between the input node 310R and the wheel cylinder 54RL. The valve unit 320RR is provided between the input node 310R and the wheel cylinder 54RR.

Each of the valve units 320FL, 320FR, 320RL, and 320RR includes a pressure increase valve 321, a pressure reduction valve 322, and a check valve 323. The pressure increase valve 321 and the pressure reduction valve 322 each is, for example, a solenoid valve.

Here, let us explain the valve unit 320FL as a representative. The pressure increase valve 321 is provided between the input node 310F and the wheel cylinder 54FL. The pressure reduction valve 322 is provided between the wheel cylinder 54FL and the reservoir 330F. For example, the pressure increase valve 321 is of a normally open type, and the pressure reduction valve 322 is of a normally closed type. The check valve 323 is so connected as to allow only the brake fluid passage in a direction from the wheel cylinder 54FL to the input node 310F. If the master pressure Pm becomes lower than the brake pressure Pfl when the pressure increase valve 321 is closed, the brake fluid flows through the check valve 323 and thereby the brake pressure Pfl is reduced.

The brake ECU 51 is able to variably control the brake pressure Pfl of the wheel cylinder 54FL by controlling an operation of the valve unit 320FL thus configured. More specifically, by opening the pressure increase valve 321 and closing the pressure reduction valve 322, it is possible to increase the brake pressure Pfl within a range not more than the master pressure Pm. On the other hand, by closing the pressure increase valve 321 and opening the pressure reduction valve 322, it is possible to move the brake fluid from the wheel cylinder 54FL to the reservoir 330F to reduce the brake pressure Pfl. In this manner, it is possible to variably control the brake pressure Pfl by controlling opening/closing of the pressure increase valve 321 and the pressure reduction valve 322.

The same applies to the other valve units 320FR, 320RL, and 320RR. In the cases of the valve units 320RL and 320RR, the term “input node 310F” shall be replaced with “input node 310R” and the term “reservoir 330F” shall be replaced with “reservoir 330R”.

The pump unit 350 is configured to return the brake fluids from the reservoirs 330F and 330R to the input nodes 310F and 310R, respectively, in accordance with an instruction from the brake ECU 51. More specifically, the pump unit 350 includes pumps 351F and 351R, check valves 352F and 352R, check valves 353F and 353R, and a motor unit 355.

The pump 351F is provided between the reservoir 330F and the input node 310F, and configured to return the brake fluid from the reservoir 330F to the input node 310F. The check valve 352F is so connected as to allow only the brake fluid passage in a direction from the reservoir 330F to the pump 351F. The check valve 353F is so connected as to allow only the brake fluid passage in a direction from the pump 351F to the input node 310F. The check valve 353F prevents the pump 351F from being applied with a high-pressure brake fluid.

Similarly, the pump 351R is provided between the reservoir 330R and the input node 310R, and configured to return the brake fluid from the reservoir 330R to the input node 310R. The check valve 352R is so connected as to allow only the brake fluid passage in a direction from the reservoir 330R to the pump 351R. The check valve 353R is so connected as to allow only the brake fluid passage in a direction from the pump 351R to the input node 310R. The check valve 353R prevents the pump 351R from being applied with a high-pressure brake fluid.

The motor unit 355 performs a driving control of the pumps 351F and 351R. More specifically, the motor unit 355 includes a motor for driving the pumps 351F and 351R and a motor controller for controlling an operation of the motor. The motor controller receives a driving command from the brake ECU 51 and generates a motor driving command according to the received driving command. Then, the motor controller outputs the motor driving command to the motor to drive the motor and thus the pumps 351F and 351R. By driving the pumps 351F and 351R, it is possible to return the brake fluids from the reservoirs 330F and 330R to the input nodes 310F and 310R, respectively.

It should be noted that the configuration of the brake actuator 300 is not limited to that shown in FIG. 3. Any configuration will do as long as it can change the brake pressures Pfl, Pfr, Prl, and Prr individually in accordance with an instruction from the brake ECU 51. For example, the following configuration may be adopted: that is, a master cutoff valve is provided between the master cylinder 100 and each of the input nodes 310F and 310R, and the brake pressures Pfl, Pfr, Prl, and Prr can be increased by driving the pumps 351F and 351R.
3. Two modes of Automatic Brake Control

The brake ECU 51 performs an “automatic brake control” that changes the braking force independently of an operation of the brake pedal 52. According to the present embodiment, two kinds of modes are available as a mode of the automatic brake control: a “first mode” and a “second mode”. The first mode and the second mode will be described below in detail.

Note that, in the description below, brake pressures of the left front wheel 10FL, the right front wheel 10FR, the left rear wheel 10RL, and the right rear wheel 10RR mean the brake pressures Pfl, Pfr, Prl, and Prr of the wheel cylinders 54FL, 54FR, 54RL, and 54RR, respectively. Valve units for the left front wheel 10FL, the right front wheel 10FR, the left rear wheel 10RL, and the right rear wheel 10RR mean the valve units 320FL, 320FR, 320RL, and 320RR connected to the wheel cylinders 54FL, 54FR, 54RL, and 54RR, respectively.

A wheel whose brake pressure is changed among the left front wheel 10FL, the right front wheel 10FR, the left rear wheel 10RL, and the right rear wheel 10RR is hereinafter referred to as a “target wheel 10T”. The valve unit for the target wheel 10T is hereinafter referred to as a “valve unit 320T”. The brake pressure of the target wheel 10T is hereinafter referred to as a “brake pressure Pt”. A wheel other than the target wheel 10T is hereinafter referred to as a “non-target wheel 10NT”. The valve unit for the non-target wheel 10NT is hereinafter referred to as a “valve unit 320NT”. The brake pressure of the non-target wheel 10NT is hereinafter referred to as a “brake pressure Pnt”.
3-1. First mode

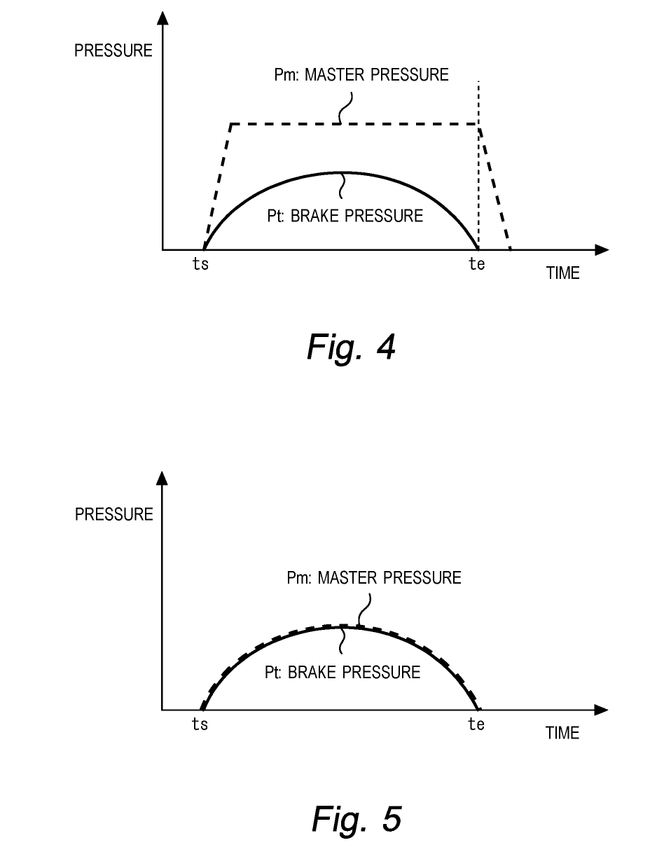

FIG. 4 is a timing chart showing the master pressure Pm and the brake pressure Pt of the target wheel 10T in the case of the first mode. A horizontal axis represents the time, and a vertical axis represents the pressure. The automatic brake control with respect to the target wheel 10T is performed during a period from a time is to a time te.

The brake ECU 51 operates the master pressure changing device 200 to increase the master pressure Pm to a certain level. Meanwhile, the brake ECU 51 calculates, based on the detected information received form the sensor group 70, a target value of the brake pressure Pt of the target wheel 10T required for the automatic brake control. The target value is hereinafter referred to as a “target brake pressure”. The brake ECU 51 operates the brake actuator 300 to make the target brake pressure.

More specifically, regarding the non-target wheel 10NT, the brake ECU 51 closes the pressure increase valve 321 and the pressure reduction valve 322 of the valve unit 320NT. As a result, the brake pressure Pnt of the non-target wheel 10NT is maintained without being affected by the master pressure Pm. On the other hand, regarding the target wheel 10T, the brake ECU 51 controls the operation of the valve unit 320T such that the target brake pressure is achieved. For example, opening the pressure increase valve 321 and closing the pressure reduction valve 322 make it possible to increase the brake pressure Pt. On the other hand, closing the pressure increase valve 321 and opening the pressure reduction valve 322 make it possible to reduce the brake pressure Pt. In this manner, by controlling opening/closing of the pressure increase valve 321 and the pressure reduction valve 322, it is possible to control the brake pressure Pt to be the target brake pressure.

As shown in FIG. 4, the first mode is characterized in that the brake pressure Pt of the target wheel 10T does not change in conjunction with the master pressure Pm. That is, in the first mode, the brake ECU 51 operates the brake actuator 300 to change the brake pressure Pt of the target wheel 10T without linkage to the master pressure Pm.

The first mode described above is a conventional method of the automatic brake control. The first mode includes the method disclosed in Patent Literature 1 (JP-2015-143058) as well. That is, in the first mode, the level of the master pressure Pm may be increased in a step-by-step manner.

3-2. Second Mode

FIG. 5 is a timing chart showing the master pressure Pm and the brake pressure Pt of the target wheel 10T in the case of the second mode. A horizontal axis and a vertical axis in FIG. 5 are the same as in the case of FIG. 4. The second mode is characterized in that the brake pressure Pt of the target wheel 10T changes in conjunction with the master pressure Pm, which is different from the case of the first mode.

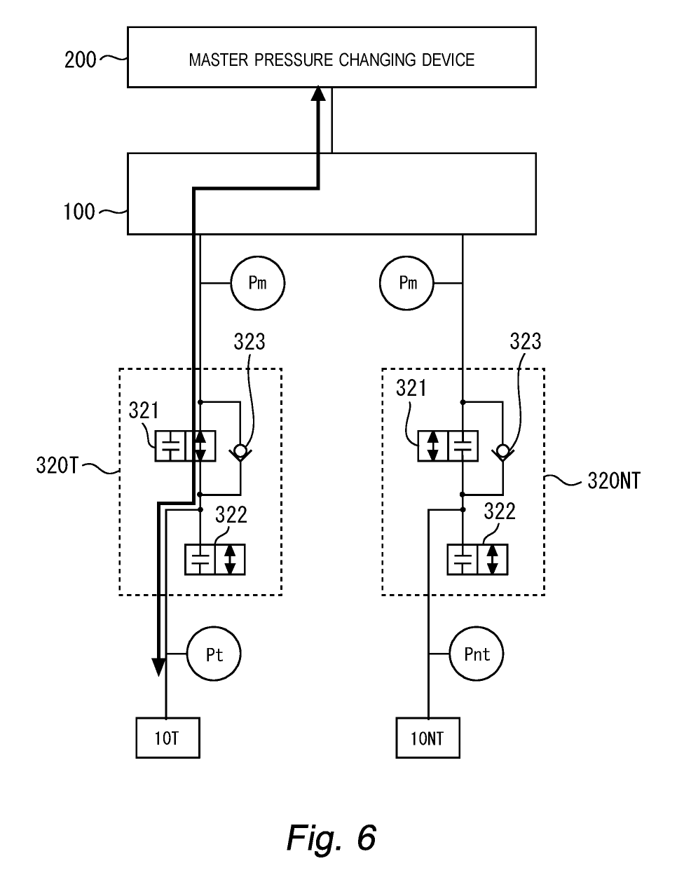

Referring to FIG. 6, a method of realizing the second mode will be described. Regarding the target wheel 10T, the brake ECU 51 opens the pressure increase valve 321 of the valve unit 320T and closes the pressure reduction valve 322 of the valve unit 320T. If the pressure increase valve 321 is of the normally open type and the pressure reduction valve 322 is of the normally closed type, the brake ECU 51 does not need to operate the valve unit 320T for the target wheel 10T. On the other hand, regarding the non-target wheel 10NT, the brake ECU 51 closes the pressure increase valve 321 and the pressure reduction valve 322 of the valve unit 320NT.

The brake ECU 51 calculates, based on the detected information received form the sensor group 70, the target brake pressure of the target wheel 10T required for the automatic brake control. Then, the brake ECU 51 operates the master pressure changing device 200 such that the master pressure Pm becomes the target brake pressure. That is, the brake ECU 51 changes the master pressure Pm in the same way as the target brake pressure. In this case, as shown in FIG. 6, the brake pressure Pt almost equal to the master pressure Pm is applied to the target wheel 10T through the valve unit 320T. As a result, the brake pressure Pt of the target wheel 10T changes in conjunction with the master pressure Pm. On the other hand, the brake pressure Pnt of the non-target wheel 10NT is maintained without change.

When there are a plurality of target wheels 10T, there is a possibility that the target brake pressure is different with respect to each of the target wheels 10T. In this case, the brake ECU 51 operates the master pressure changing device 200 such that the master pressure Pm becomes the maximum value of the target brake pressures. Even in this case, the brake pressure Pt of any target wheel 10T changes in conjunction with the master pressure Pm at any time.

As seen from the above, the second mode is characterized in that the brake pressure Pt of the target wheel 10T changes in conjunction with the master pressure Pm. That is, in the second mode, the brake ECU 51 operates the master pressure changing device 200 to change the master pressure Pm and thus to change the brake pressure Pt of the target wheel 10T in conjunction with the master pressure Pm.
4. Usage of First Mode and Second Mode

According to the present embodiment, the brake ECU 51 selects one of the first mode and the second mode depending on a “type” of the automatic brake control. One criterion for the selection is NV (Noise and Vibration) characteristics. First, let us consider the NV characteristics of each of the first mode and the second mode.
4-1. Comparison of NV characteristics

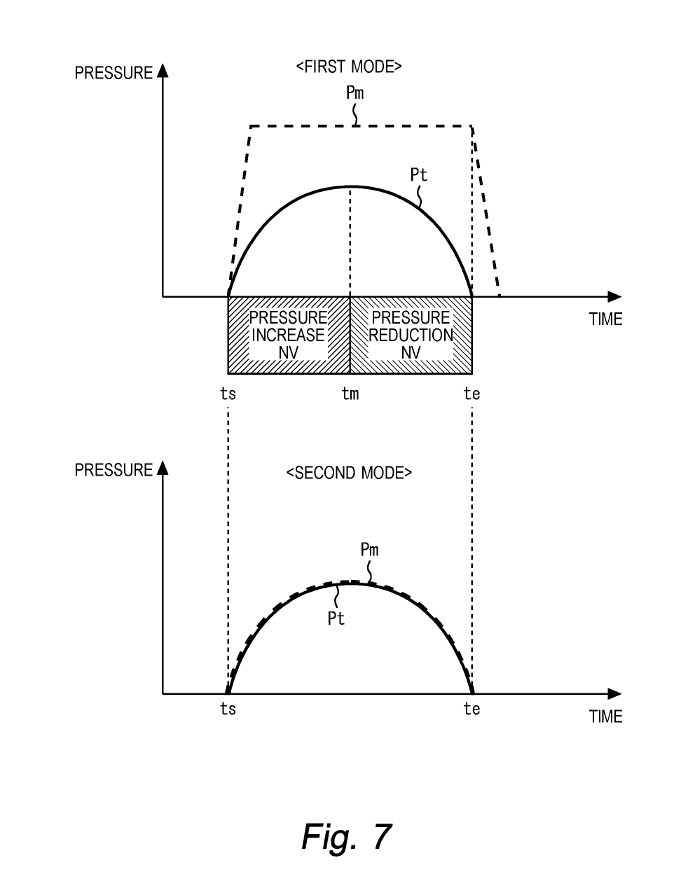

FIG. 7 is a diagram for explaining the NV characteristics of the first mode and the second mode. A horizontal axis and a vertical axis are the same as in the cases of the foregoing FIGS. 4 and 5. The automatic brake control with respect to the target wheel 10T is performed during a period from a time ts to a time te.

In the case of the first mode and during a period from the time ts to a time tm, the brake ECU 51 increases the brake pressure Pt of the target wheel 10T by controlling an opening degree of the pressure increase valve 321. During this period, the brake pressure Pt is lower than the master pressure Pm, and a difference between the master pressure Pm and the brake pressure Pt causes vibrations and hydraulic hammer sounds. Such the vibrations and noises during increase in the pressure is hereinafter referred to as “pressure-increase-NV”.

In the case of the first mode and during a period from the time tm to the time te, the brake ECU 51 reduces the brake pressure Pt of the target wheel 10T by controlling an opening degree of the pressure reduction valve 322. Moreover, the brake ECU 51 operates the pump unit 350 to return the brake fluid accumulated in the reservoirs 330F and 330R to the input nodes 310F and 310R. During this period, vibrations and pump sounds occur. Such the vibrations and noises during reduction in the pressure is hereinafter referred to as “pressure-reduction-NV”.

On the other hand, in the case of the second mode, as described above, the brake pressure Pt of the target wheel 10T changes in conjunction with the master pressure Pm, and thus there is no difference between the master pressure Pm and the brake pressure Pt. The open-close control of the pressure increase valve 321 and the pressure reduction valve 322 is not performed. Moreover, there is no need to operate the pump unit 350. Therefore, neither the pressure-increase-NV nor the pressure-reduction-NV is caused.

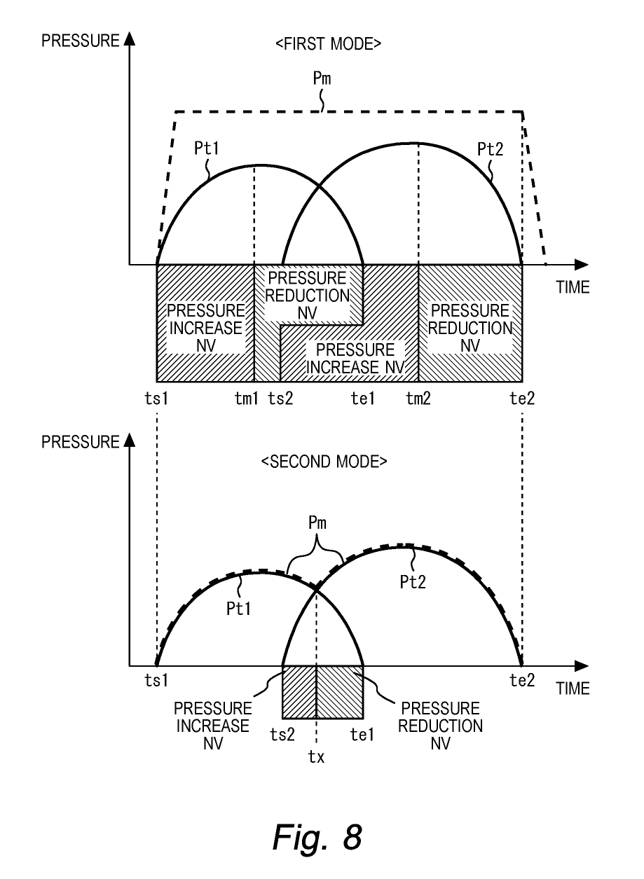

FIG. 8 shows a case where there are two target wheels 10T. The automatic brake control with respect to one target wheel 10T (hereinafter referred to as a “first target wheel”) is performed during a period from a time ts1 to a time te1. The automatic brake control with respect to the other target wheel 10T (hereinafter referred to as a “second target wheel”) is performed during a period from a time ts2 to a time te2. The control period for the first target wheel and the control period for the second target wheel partially overlap with each other.

The noises and vibrations in the first mode are as follows. During a period from the time ts1 to a time tm1, the brake pressure Pt1 of the first target wheel is increased and the pressure-increase-NV is caused. During a period from the time tm1 to the time te1, the brake pressure Pt1 of the first target wheel is reduced and the pressure-reduction-NV is caused. During a period from the time ts2 to a time tm2, the brake pressure Pt2 of the second target wheel is increased and the pressure-increase-NV is caused. During a period from the time tm2 to the time te2, the brake pressure Pt2 of the second target wheel is reduced and the pressure-reduction-NV is caused.

In the case of the second mode, the brake ECU 51 compares the target value of the brake pressure Pt1 of the first target wheel with the target value of the brake pressure Pt2 of the second target wheel. Then, the brake ECU 51 changes the master pressure Pm in accordance with the higher target value. In the example shown in FIG. 8, during a period from the time ts1 to a time tx, the target value of the brake pressure Pt1 of the first target wheel is the higher one. During a period from the time tx to the time te2, the target value of the brake pressure Pt2 of the second target wheel is the higher one.

The noises and vibrations with regard to the first target wheel in the second mode are as follows. During the period from the time ts1 to the time tx, the brake pressure Pt1 of the first target wheel changes in conjunction with the master pressure Pm, and thus neither the pressure-increase-NV nor the pressure-reduction-NV is caused. During a period from the time tx to the time te1, the target value of the brake pressure Pt1 of the first target wheel is lower than the master pressure Pm. Therefore, the brake ECU 51 reduces the brake pressure Pt1 in the same manner as in the case of the first mode. The pressure-reduction-NV is caused only during this period.

The noises and vibrations with regard to the second target wheel in the second mode are as follows. During a period from the time ts2 to the time tx, the target value of the brake pressure Pt2 of the second target wheel is lower than the master pressure Pm. Therefore, the brake ECU 51 increases the brake pressure Pt2 in the same manner as in the case of the first mode. The pressure-increase-NV is caused only during this period. During the period from the time tx to the time te2, the brake pressure Pt2 of the second target wheel changes in conjunction with the master pressure Pm, and thus neither the pressure-increase-NV nor the pressure-reduction-NV is caused.

As can be seen from the above, the noises and vibrations are dramatically reduced and thus the NV characteristics are improved in the case of the second mode as compared with the case of the first mode. The reasons are as follows: (1) the brake pressure Pt changing in conjunction with the master pressure Pm in the second mode; and (2) a considerably lower usage frequency and a considerably shorter usage time of the brake actuator 300 in the first mode as compared with the second mode.

4-2. Correspondence relationship between type of automatic brake control and usage mode

According to the present embodiment, as described above, the automatic brake control in the second mode is available in addition to the conventional first mode. In the second mode, the noises and vibrations are dramatically reduced and thus the NV characteristics are improved as compared with the first mode. Therefore, by using the second mode as needed, it is possible to suppress the noises and vibrations during the automatic brake control as compared with the conventional technique where only the first mode is used.

However, the second mode is not necessarily performed in every type of the automatic brake control. The first mode is more advantageous from a viewpoint of response ability of the brake pressure Pt of the target wheel 10T. It is therefore preferable to use the first mode in a case of the automatic brake control that gives priority to the response ability. That is to say, according to the present embodiment, the brake ECU 51 selects and uses an appropriate mode depending on the “type” of the automatic brake control.

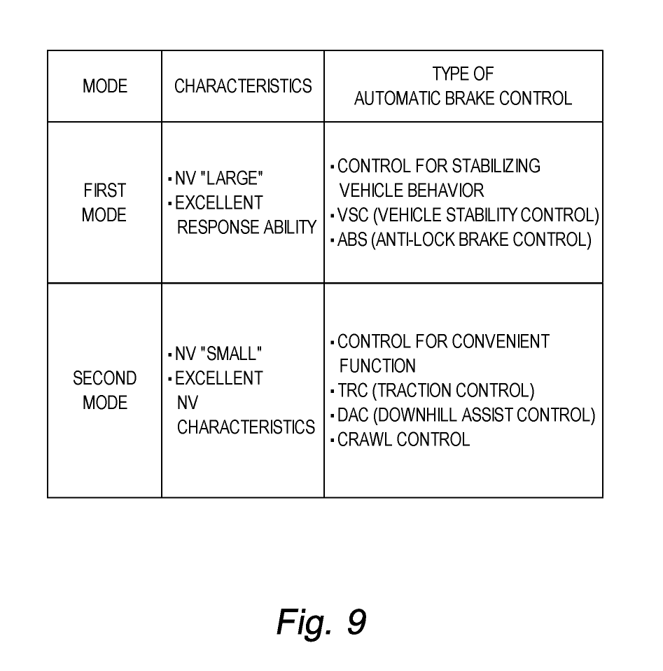

FIG. 9 is a conceptual diagram showing types of the automatic brake control to which the first mode is applied and types of the automatic brake control to which the second mode is applied.

The first mode is inferior to the second mode in terms of the NV characteristics but superior to the second mode in terms of the response ability. Therefore, when performing an automatic brake control that gives priority to the response ability, the brake ECU 51 selects the first mode as a usage mode. Typically, the automatic brake control that gives priority to the response ability is for stabilizing a behavior of the vehicle 1. Such the automatic brake control is exemplified by a vehicle stability control and an anti-lock brake control.

The vehicle stability control is an automatic brake control for stabilizing a behavior of the vehicle 1 during cornering and is also called VSC (Vehicle Stability Control). For example, when a cornering state of the vehicle 1 is oversteer, the brake ECU 51 can resolve the oversteer by applying the brake to an outer front wheel. When the cornering state of the vehicle 1 is understeer, the brake ECU 51 can resolve the understeer by applying the brake to an inner front wheel. It is possible to effectively perform the vehicle stability control by using the first mode with excellent response ability.

The anti-lock brake control is an automatic brake control for preventing a wheel from locking up during braking and is also called ABS (Antilock Brake System) control. For example, if a rear wheel locks up, the vehicle 1 is more likely to go spinning. On the other hand, if a front wheel locks up, steering is deteriorated. Therefore, when detecting a wheel exhibiting a locking-up sign, the brake ECU 51 reduces the brake pressure of the wheel to prevent the locking-up and thus stabilize the vehicle 1. It is possible to effectively perform the anti-lock brake control by using the first mode with excellent response ability.

The second mode is inferior to the first mode in terms of the response ability but superior to the first mode in terms of the NV characteristics. Therefore, when performing an automatic brake control that does not necessarily require the excellent response ability, the brake ECU 51 gives priority to the NV characteristics and selects the second mode as the usage mode. Typically, the automatic brake control that does not necessarily require the excellent response ability is for a convenient function. Such the automatic brake control is exemplified by a traction control, a downhill assist control, and a crawl control.

The traction control is an automatic brake control for suppressing wheel spin when starting or accelerating the vehicle 1 and is also called TRC (TRaction Control). For example, when detecting spin of a driving wheel at the time of starting, the brake ECU 51 can suppress the wheel spin by applying the brake to the driving wheel. By using the second mode with excellent NV characteristics, it is possible to reduce the noises and vibrations when the traction control is performed.

The downhill assist control is an automatic brake control for assisting driving of the vehicle 1 on a downhill and is also called DAC (Downhill Assist Control). For example, when the braking operation is performed on a steep downhill, a wheel may lock up. The DAC controls the brake pressure so as to suppress slip and locking-up of the wheel, and also keeps the vehicle speed at a low speed. As a result, the driver can concentrate on a steering operation without worries. By using the second mode with excellent NV characteristics, it is possible to reduce the noises and vibrations when the downhill assist control is performed.

The crawl control is an automatic brake control for assisting crawl running (extremely low-speed running) of the vehicle 1. As an example, let us consider a case where the crawl running is performed on a very rough road or slippery sandy track. The crawl control controls the brake pressure so as to suppress slip and locking-up of the wheel, and also keeps the vehicle speed at an extremely low speed. As a result, the driver can concentrate only on a steering operation. By using the second mode with excellent NV characteristics, it is possible to reduce the noises and vibrations when the crawl control is performed.
4-3. Processing by brake ECU

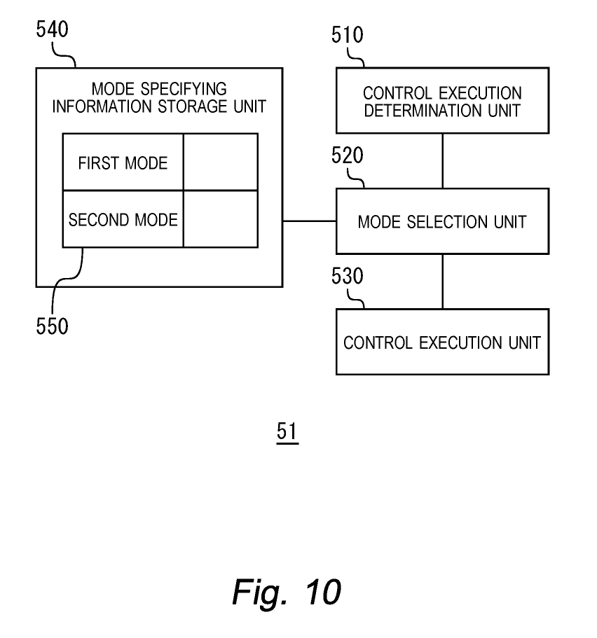

FIG. 10 is a block diagram showing functions of the brake ECU 51 according to the present embodiment. The brake ECU 51 has a control execution determination unit 510, a mode selection unit 520, a control execution unit 530, and a mode specifying information storage unit 540 as function blocks.

The mode specifying information storage unit 540 is realized by the memory of the brake ECU 51. Mode specifying information 550 is stored in the mode specifying information storage unit 540. The mode specifying information 550 indicates the types of the automatic brake control to which the first mode is applied and the types of the automatic brake control to which the second mode is applied, like the foregoing FIG. 9. In other words, the mode specifying information 550 indicates whether to use the first mode or the second mode with respect to each type of the automatic brake control.

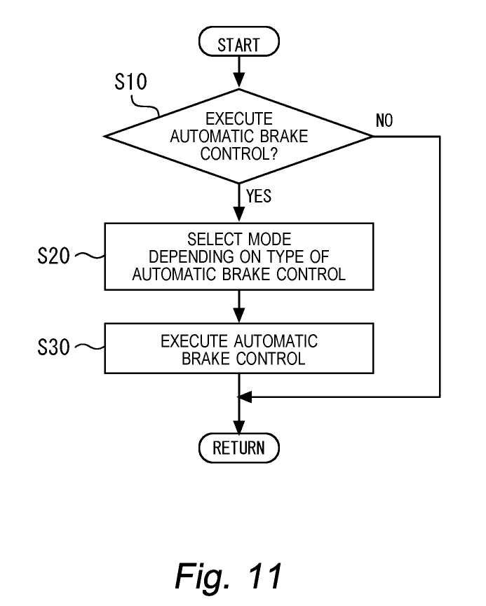

The control execution determination unit 510, the mode selection unit 520, and the control execution unit 530 are realized by the processor of the brake ECU 51 executing a control program stored in the memory. Processing by these function blocks will be described with reference to a flow chart shown in FIG. 11. Note that the brake ECU 51 repeatedly executes the processing flow shown in FIG. 11.

Step S10:

The control execution determination unit 510 determines whether or not to execute an automatic brake control. If it is determined to execute an automatic brake control (Step S10; Yes), the processing proceeds to Step S20.

For example, the control execution determination unit 510 monitors the cornering state of the vehicle 1 in order to determine whether or not to execute the vehicle stability control. More specifically, the control execution determination unit 510 calculates a target yaw rate by a well-known method based on a steering angle and a vehicle speed. The steering angle is detected by the steering angle sensor 72. The vehicle speed is detected by the vehicle speed sensor 74. Alternatively, the vehicle speed may be calculated from rotational speeds of the left front wheel 10FL, the right front wheel 10FR, the left rear wheel 10RL, and the right rear wheel 10RR respectively detected by the wheel speed sensors 71FL, 71FR, 71RL, and 71RR. In addition, the control execution determination unit 510 obtains an actual yaw rate detected by the yaw rate sensor 78. Then, the control execution determination unit 510 compares the target yaw rate with the actual yaw rate to detect the oversteer or the understeer. If the oversteer or the understeer is detected, then the control execution determination unit 510 determines to execute the vehicle stability control.

As another example, the control execution determination unit 510 calculates a slip amount or a slip ratio of each wheel in order to determine whether or not to execute the anti-lock brake control. The control execution determination unit 510 can calculate the slip amount or the slip ratio of each wheel based on the rotational speed of each wheel and the vehicle speed. The rotational speed of each wheel is detected by the wheel speed sensor 71FL, 71FR, 71RL, or 71RR. If the slip amount or the slip ratio of a certain wheel exceeds a threshold value, the control execution determination unit 510 judges that said certain wheel exhibits a locking-up sign and determines to execute the anti-lock brake control.

As still another example, the control execution determination unit 510 can detect wheel spin based on the rotational speed of each wheel and the vehicle speed. If the wheel spin is detected, the control execution determination unit 510 determines to execute the traction control.

As still another example, if a switch for the downhill assist control is turned ON by the driver, the control execution determination unit 510 determines to execute the downhill assist control. The same applies to the crawl control.

Step S20:

The mode selection unit 520 selects, as the usage mode, any one of the first mode and the second mode depending on the type of the automatic brake control to be executed. More specifically, the mode selection unit 520 refers to the mode specifying information 550 stored in the mode specifying information storage unit 540 to select the one mode specified with respect to the type of the automatic brake control to be executed. Since the mode specifying information 550 is prepared and retained beforehand, it is possible to easily and quickly select the usage mode.

Step S30:

The control execution unit 530 executes the automatic brake control while successively setting the target wheel 10T and calculating the target brake pressure. Here, the control execution unit 530 executes the automatic brake control based on the usage mode selected at Step S20 (see FIGS. 4 to 8).
4-4. Effects

According to the present embodiment, as described above, the automatic brake control in the second mode is available in addition to the conventional first mode. In the second mode, the noises and vibrations are dramatically reduced and thus the NV characteristics are improved as compared with the first mode. Therefore, by using the second mode as needed, it is possible to suppress the noises and vibrations during the automatic brake control as compared with the conventional technique where only the first mode is used.

In addition to that, the first mode is used in the case of the automatic brake control that gives priority to the response ability. That is to say, according to the present embodiment, an appropriate mode is selected and used depending on the “type” of the automatic brake control. It can be said that the present embodiment well balances between the NV characteristics and the response ability.

What is claimed is:

1. A brake control device for a vehicle, comprising:
a master cylinder configured to output a brake fluid of a master pressure;
a master pressure changing device configured to change the master pressure independently of an operation of a brake pedal;
a brake actuator configured to supply the brake fluid output from the master cylinder to a wheel cylinder of each wheel, and to control a brake pressure of the brake fluid supplied to the wheel cylinder; and
a control device configured to perform an automatic brake control that changes the brake pressure of a target wheel independently of an operation of the brake pedal,
wherein modes of the automatic brake control include a first mode and a second mode,
wherein in the first mode, the control device operates the brake actuator to make a target value of the brake pressure of the target wheel,
wherein in the second mode, the control device operates the master pressure changing device such that the master pressure becomes the target value of the brake pressure to change the brake pressure of the target wheel in conjunction with the master pressure, and
wherein the control device selects one of the first mode and the second mode depending on a type of the automatic brake control.

2. The brake control device according to claim 1,
wherein the control device retains mode specifying information that indicates whether to use the first mode or the second mode with respect to each type of the automatic brake control, and
wherein when performing the automatic brake control, the control device refers to the mode specifying information to select one mode specified with respect to the type of the automatic brake control.

3. The brake control device according to claim 1,
wherein when the automatic brake control is a vehicle stability control for stabilizing a behavior of the vehicle during cornering, the control device selects the first mode.

4. The brake control device according to claim 1,
wherein when the automatic brake control is an anti-lock brake control for preventing a wheel from locking up during braking, the control device selects the first mode.

5. The brake control device according to claim 1,
wherein when the automatic brake control is a traction control for suppressing wheel spin when starting or accelerating, the control device selects the second mode.

6. The brake control device according to claim 1,
wherein when the automatic brake control is a downhill assist control for assisting driving of the vehicle on a downhill, the control device selects the second mode.

7. The brake control device according to claim 1,
wherein when the automatic brake control is a crawl control for assisting crawl running of the vehicle, the control device selects the second mode.

8. The brake control device according to claim 1, wherein the brake actuator comprises:
an input node to which the brake fluid output from the master cylinder is input;
a pressure increase valve provided between the input node and the wheel cylinder with respect to each wheel;
a pressure reduction valve provided between the wheel cylinder and a reservoir with respect to each wheel; and
a pump configured to return the brake fluid from the reservoir to the input node,
wherein when increasing the brake pressure of the target wheel in the first mode, the control device opens the pressure increase valve for the target wheel and closes the pressure reduction valve for the target wheel,
wherein when decreasing the brake pressure of the target wheel in the first mode, the control device closes the pressure increase valve for the target wheel and opens the pressure reduction valve for the target wheel, and
wherein when changing the brake pressure of the target wheel in the second mode, the control device opens the pressure increase valve for the target wheel, closes the pressure reduction valve for the target wheel, and uses the master pressure changing device to change the master pressure.
